(19) United States
(12) Patent Application Publication
(10) Pub. No.: US 2025/0299400 A1
(43) Pub. Date: Sep. 25, 2025

(54) Action Processing Device, Action Processing Method, and Action Processing Program

(71) Applicant: Hitachi, Ltd., Tokyo (JP)

(72) Inventors: Shunsuke MINUSA, Tokyo (JP); Tadayuki MATSUMURA, Tokyo (JP); Kanako ESAKI, Tokyo (JP)

(21) Appl. No.: 19/043,601

(22) Filed: Feb. 3, 2025

(30) Foreign Application Priority Data
Mar. 22, 2024 (JP) 2024-046713

(51) Int. Cl. G06T 11/60; G06T 13/00

(52) U.S. Cl. CPC G06T 11/60; G06T 13/00

(57) ABSTRACT

To perform more appropriate evaluation on an action related to communication.

An action processing device 1 for evaluating an action related to communication of a group of action subjects performing the communication with each other includes a group state index calculation unit 104 configured to calculate, based on second sensing information of a second group to be evaluated, a second group state index related to a state of communication in the second group, a vector information generation unit 105 configured to generate visible information based on the second group state index and to generate second vector information by vectorizing the visible information, and an action evaluation unit configured to evaluate the action of the second group based on a first group state index associated with a piece of first vector information whose comparison result with the second vector information satisfies a predetermined condition among pieces of first vector information serving as a reference of the knowledge database.

### CLAIM OF PRIORITY

The present application claims priority from Japanese Patent Application JP 2024-046713 filed on Mar. 22, 2024, the content of which are hereby incorporated by references into this application.

### BACKGROUND OF THE INVENTION

### 1. Field of the Invention

The present invention relates to a technique for evaluating an action related to communication between action subjects.

### 2. Description of Related Art

Currently, communication is evaluated in a variety of fields. For example, a test related to interpersonal communication is performed by a doctor or the like. In addition, in communication between two parties, such as counselor-client, sales staff-customer, or leader-follower, training in interview techniques is essential for the former, who acts as a leader, to effectively affect the latter. For example, counselors receive training in interview techniques through good counseling video instruction and role-playing during their education.

Here, in order to perform good communication including an interview or other setting, it is essential to master not only verbal responses such as the content of utterance, but also nonverbal response techniques, which are a type of nonverbal action. For example, it is known that in counseling evaluated as good, synchrony of a response of an utterance between a counselor and a client or a body action is high. However, as compared with verbal responses, the quality of nonverbal response techniques cannot be adequately acquired through training such as watching videos or role-playing, and the nonverbal response techniques are highly individual skills that are acquired through trial and error.

PTL 1 has proposed a technique for appropriately “providing appropriate support to those being graded when scoring interpersonal communication that requires dialogue skills”. PTL 1 discloses “an information processing device including a processing unit for scoring a dialog between a first speaker present in a first space and a second speaker present in a second space different from the first space based on reference information serving as a reference for the dialogue scoring, and presenting, to the first speaker, the scoring information on the scoring of the conversation in real time”.

### CITATION LIST

### Patent Literature

PTL 1: WO2022/102432

### SUMMARY OF THE INVENTION

In PTL 1, a scoring method is biased towards verbal response techniques in fields where it is easy for the person being scored, such as a doctor and a pharmacist, to clearly state and provide examples of what they should say. Therefore, the evaluation of the nonverbal response technique based on the sensing information is not sufficient. In particular, when rapport building is immature in the early stages of counseling, the client's response to the counselor's (the person being scored) utterances may be at odds with his or her actual thoughts, making it difficult to give a more appropriate evaluation.

For this reason, in PTL 1, there is a concern that the intervention support for the action related to communication is insufficient. An object of the invention is to perform more appropriate evaluation on an action related to communication.

In order to achieve the object, the invention has adopted an action processing device for evaluating an action related to communication of a group of action subjects performing the communication with each other. The action processing device includes a storage unit configured to store a knowledge database in which a first group state index related to a state of communication in a first group is associated with first vector information generated based on the first group state index and indicating a feature of the action, an input unit configured to receive second sensing information indicating an action related to communication in a second group, a group state index calculation unit configured to calculate a second group state index related to a state of the communication in the second group based on the second sensing information, a vector information generation unit configured to generate visible information indicating a state related to the communication of the second group based on the second group state index and to generate second vector information by vectorizing the visible information, and an action evaluation unit configured to evaluate the action of the second group based on a first group state index associated with a piece of first vector information whose comparison result with the second vector information satisfies a predetermined condition among pieces of the first vector information included in the knowledge database.

The invention also provides an action processing method executed by the action processing device, an action processing program for causing the action processing device to function as a computer, and a storage medium storing the action processing program. Further, the invention also provides an action processing system including the action processing device.

According to the invention, an action related to communication can be more appropriately evaluated.

### BRIEF DESCRIPTION OF THE DRAWINGS

FIG. 1 is a functional block diagram of an action processing device 1 in an embodiment of the invention;

FIG. 2 is a configuration diagram showing an implementation example of an action processing system in Embodiment 1;

FIG. 3A is a diagram showing sensing information 81 used in Embodiment 1;

FIG. 3B is a diagram showing a sensing feature 82 used in Embodiment 1;

FIG. 3C is a diagram showing a group state index 83 used in Embodiment 1;

FIG. 3D is a diagram showing additional information 84 used in Embodiment 1;

FIG. 3E is a diagram showing a knowledge database 85 used in Embodiment 1;

FIG. 3F is a diagram showing action subject property information 87 used in Embodiment 1;

FIG. 3G is a diagram showing an intervention determination method 90 used in Embodiment 1;

FIG. 4 is a flowchart showing sensing information collection processing in Embodiment 1;

FIG. 5 is a flowchart showing construction processing of a knowledge DB 85 in Embodiment 1;

FIG. 6 is a flowchart showing generation processing of an explanatory text and vector information in Embodiment 1;

FIG. 7 is a flowchart showing an action evaluation processing in Embodiment 1;

FIG. 8 is a flowchart showing details of step S74 of the action evaluation processing in Embodiment 1;

FIG. 9 is a diagram showing a display screen of an intervention action in Embodiment 1;

FIG. 10 is a diagram showing a display screen of another intervention action in Embodiment 1;

FIG. 11 is a configuration diagram showing an implementation example of an action processing system in Embodiment 2; and

FIG. 12 is a flowchart showing action evaluation processing according to Embodiment 2.

### DESCRIPTION OF EMBODIMENTS

In the present embodiment, an action related to communication between action subjects in a group including a plurality of action subjects is evaluated. The action subjects have a relationship such as counselor-client, sales staff-customer, and leader-follower. The action subject may be a natural person or may be a virtual human that acts autonomously, such as a robot, an avatar, or a chatbot (automatic conversation program) (hereinafter referred to as a virtual human). The communication also includes N-to-M communication in addition to one-to-one communication. The communication also includes communication involving three or more units, such as one-to-one-to-one . . . , for example, facilitation of a conversation at a round table. Therefore, a target group in the present embodiment includes two or more (persons) action subjects.

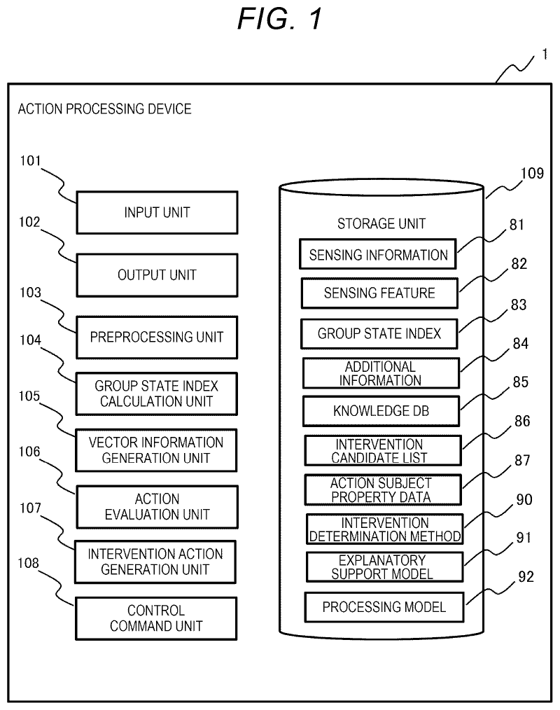

Hereinafter, an action processing device 1 that executes processing in the present embodiment will be described. FIG. 1 is a functional block diagram of the action processing device 1 in the present embodiment. The action processing device 1 includes an input unit 101, an output unit 102, a preprocessing unit 103, a group state index calculation unit 104, a vector information generation unit 105, an action evaluation unit 106, an intervention action generation unit 107, a control command unit 108, and a storage unit 109.

First, the input unit 101 receives sensing information indicating an action of an action subject. The sensing information includes nonverbal information indicating a nonverbal action as an action. The nonverbal action indicated by the nonverbal information includes a posture of an action subject, an action such as nodding, a tone and size of a voice, a heart rate, body temperature, blinking, eyeball movement, pupil, electromyography, and a brain wave. Therefore, the nonverbal information includes not only a conscious action but also a reaction. When the action subject is a virtual human, an internal state such as a joint angle of a robot or a virtual operation of an avatar is included. In addition, audio-related information, included in audio content, may be selectively used as the sensing information.

The sensing information may include verbal information. Further, the sensing information is not limited to the information detected by the sensor. For example, when a specific condition is satisfied, information indicating pressing of a button by an action subject is also included in the sensing information. The input unit 101 can be implemented by an input device such as a keyboard or a communication device. The input unit 101 can be implemented by a combination of a program for operating the input device and the communication device and a module constituting the program.

The output unit 102 outputs an evaluation result in the action evaluation unit 106 and an intervention action generated by the intervention action generation unit 107. Therefore, the output unit 102 can be implemented by a display device such as a monitor or a communication device. Further, the output unit 102 can be implemented by a combination of a program for operating the display device and the communication device and a module constituting the program.

The preprocessing unit 103 performs preprocessing on the received sensing information to enable subsequent processing. The preprocessing includes noise reduction, outlier processing, and feature extraction. The group state index calculation unit 104 calculates, based on the sensing information, a group state index related to a state of communication in a group for which the sensing information is detected, and more preferably a group state index by which the state is evaluated (hereinafter, simply referred to as a group state index related to the state of communication). Here, at least one of a synchrony index and an information flow index of an action subject in the action can be used as the group state index. For this reason, it is desirable that the group state index calculation unit 104 calculates the group state index based on a sensing feature.

The vector information generation unit 105 generates, based on the sensing information and the group state index, visible information indicating a state related to communication of the corresponding group, vectorizes the visible information, and generates vector information. Here, the visible information is information obtained by visualizing the state related to communication of a group, and at least one of the explanatory text and the video information can be used. Here, the video information refers to image information having time information (temporal elements), and is not limited to one unit (for example, a file). The video information may be implemented by a plurality of pieces of still image information. The visible information may be editable in response to an operation from a user. It is desirable that the vector information generation unit 105 generates visible information using the sensing feature and the group state index generated based on the sensing information.

The action evaluation unit 106 evaluates an action of a group indicated by one piece of vector information based on a comparison result of two pieces of vector information. As an example, a knowledge database 85 is used in advance. The knowledge database 85 associates first sensing information indicating an action related to communication in a first group, a first group state index related to a state of communication in the first group, and first vector information. The first vector information indicates the feature of the action of the action subject in the first group, and is generated based on the first sensing information and the first group state index.

Then, the action evaluation unit 106 evaluates an action of the second group. For this reason, the action evaluation unit 106 performs the evaluation based on the first group state index associated with a piece of first vector information, among pieces of first vector information in the knowledge database 85, and a difference between the piece of first vector information and the second vector information received by the input unit 101 is within a predetermined threshold value. Further, the action evaluation unit 106 may specify an action of the group indicated by one piece of vector information based on the comparison result of the two pieces of vector information.

The intervention action generation unit 107 generates an intervention action for an action subject based on at least one of the evaluation result and the action in the action evaluation unit 106. The intervention action includes advice related to the action. The control command unit 108 generates a control command for a virtual human according to the intervention action generated by the intervention action generation unit 107 or the action specified by the action evaluation unit 106. The control command unit 108 may be omitted.

The storage unit 109 stores sensing information 81, sensing feature 82, group state index 83, additional information 84, the knowledge database 85 (knowledge DB 85), an intervention candidate list 86, an action subject property information 87, an intervention determination method 90, an explanatory support model 91, and a processing model 92. These will be described in the following embodiments. The present embodiment has been described above, and Embodiment 1 and Embodiment 2 specifically illustrating the present embodiment will be described below.

### Embodiment 1

In Embodiment 1, a counselor and a client are used as action subjects (also referred to as actors) constituting a group. Here, communications such as consultation and counseling for the problem or the like are provided between the counselor and the client. When a client becomes nervous in response to his worries, nonverbal actions such as an increased heart rate and a higher-pitched voice may occur. Such nonverbal actions may occur during communication such as consultation or counseling, or may also occur before and after the communication. Therefore, in Embodiment 1, nonverbal actions before and after communication can also be used.

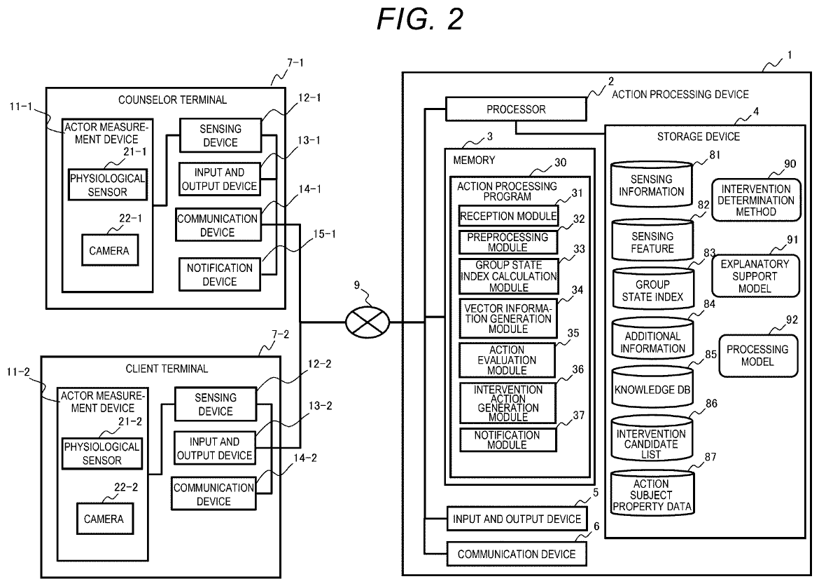

Embodiment 1 is an example in which an action of a group is evaluated by an action processing system including the action processing device 1. Hereinafter, a hardware structure of the action processing system will be described with reference to FIG. 2. FIG. 2 is a configuration diagram illustrating an implementation example of the action processing system according to Embodiment 1. In the action processing system, the action processing device 1 is connected to a counselor terminal 7-1 and a client terminal 7-2 used by action subjects via a network 9. The action processing device 1 evaluates an action of a group including a counselor and a client respectively using the counselor terminal 7-1 and the client terminal 7-2.

First, the action processing device 1 can be implemented by a computer called a so-called server, and is installed in the same place, data center, or the like as the counselor terminal 7-1 and the client terminal 7-2. The action processing device 1 includes a processor 2, a memory 3, a storage device 4, an input and output device 5, and a communication device 6, which are connected to one another via a communication path such as a bus.

The processor 2 is also referred to as a calculation device or a processing device, and executes processing of each unit in FIG. 1 in accordance with various programs to be described below. The memory 3 is also referred to as a main storage device, and for processing in the processor 2, a program stored in a storage medium such as the storage device 4 or information used in processing in the program is loaded. That is, as shown in FIG. 2, the action processing program 30 is loaded into the memory 3.

The action processing program 30 includes a reception module 31, a preprocessing module 32, a group state index calculation module 33, a vector information generation module 34, an action evaluation module 35, an intervention action generation module 36, and a notification module 37. These modules cause the processor 2 to execute functions of the units in FIG. 1, and the correspondence relationship is as follows.
Input unit 101: reception module 31
Output unit 102: notification module 37
Preprocessing unit 103: preprocessing module 32
Group state index calculation unit 104: group state index calculation module 33
Vector information generation unit 105: vector information generation module 34
Action evaluation unit 106: action evaluation module 35
Intervention action generation unit 107: intervention action generation module 36

Therefore, the action processing program 30 causes the processor 2 to execute processing of the input unit 101, the output unit 102, the preprocessing unit 103, the group state index calculation unit 104, the vector information generation unit 105, the action evaluation unit 106, the intervention action generation unit 107, and the control command unit 108. Regarding the input unit 101 and the output unit 102, the reception module 31 and the notification module 37 implement functions of the input and output device 5 and the communication device 6. These modules may be implemented by programs independent of each other, or may be implemented by programs obtained by combining a part of the programs independent of each other.

The action processing program 30 is distributed via the network 9 or stored in a storage medium, and installed in the action processing device 1. Note that the action processing device 1 may be implemented as a work support device that supports the work of a counselor. In this case, the action processing program 30 may be implemented as one function of the work support program.

The storage device 4 is also referred to as a secondary storage device, and can be implemented by a storage such as a hard disk drive. The storage device 4 stores the action processing program 30 and various kinds of information (sensing information 81, etc.). As described above, the storage device 4 and the memory 3 correspond to the storage unit 109 shown in FIG. 1. Here, the storage device 4 stores the following information as the information used in Embodiment 1. That is, the sensing information 81, the sensing feature 82, the group state index 83, the additional information 84, the knowledge database 85 (knowledge DB 85), the intervention candidate list 86, the action subject property information 87, the intervention determination method 90, the explanatory support model 91, and the processing model 92 are stored. At least one of the various kinds of information in the storage device 4 may be stored in a database system or a file device in a separate housing from the action processing device 1.

The input and output device 5 is an input device and a display device, and may be configured as separate devices or may be integrated into one device such as a touch panel. In the example shown in FIG. 2, the input and output device 5 is provided because a computer usable by a user such as a supervisor is shown as the action processing device 1. However, when the action processing device 1 is implemented by a large computer provided in a data center, the input and output device 5 can be omitted. The input and output device 5 may be implemented by a terminal device (a computer such as a tablet) in a separate housing from the action processing device 1. The input and output device 5 executes the functions of the input unit 101 and the output unit 102 in FIG. 1 in cooperation with the reception module 31 and the notification module 37.

The communication device 6 has an interface function for connecting to the network 9, and communicates with the counselor terminal 7-1 and the client terminal 7-2. Therefore, the communication device 6 also functions as the input unit 101 and the output unit 102 in FIG. 1 in cooperation with the reception module 31 and the notification module 37.

Next, the counselor terminal 7-1 is a terminal device used by the counselor who is an actor 1 as a user, and can be implemented by a computer such as a PC, a smartphone, or a tablet terminal. The counselor terminal 7-1 includes an actor measurement device 11-1, a sensing device 12-1, an input and output device 13-1, a communication device 14-1, and a notification device 15-1, which are connected to one another via a communication path.

First, the actor measurement device 11-1 measures an action of the counselor who is the actor 1. Therefore, the actor measurement device 11-1 can be implemented by a physiological sensor 21-1 for measuring a pulse of the counselor the like or a camera 22-1. Examples of the camera 22-1 include a camera for capturing an appearance of a counselor, and a so-called thermography camera, and can measure physical movements (including head movement) and body temperature of the counselor.

The sensing device 12-1 creates sensing information indicating an action of the actor 1 in accordance with a measurement result obtained by the actor measurement device 11-1. In addition, the input and output device 13-1 is an input device or a display device for a counselor, and may be configured as separate devices or may be integrated into one device such as a touch panel.

The communication device 14-1 has an interface function for connecting to the network 9, and communicates with the action processing device 1 and the client terminal 7-2. In addition, the notification device 15-1 outputs processing content such as the evaluation result of the action obtained by the action processing device 1, the sensing information created by the sensing device 12-1, and the like.

Next, the client terminal 7-2 is a terminal device used by a client who is an actor 2 as a user, and can be implemented by a computer such as a PC, a smartphone, a tablet terminal, or a wearable computer. The client terminal 7-2 includes an actor measurement device 11-2, a sensing device 12-2, an input and output device 13-2, and a communication device 14-2, which are connected to one another via a communication path. The actor measurement device 11-2, the sensing device 12-2, the input and output device 13-2, and the communication device 14-2 have the same functions as the actor measurement device 11-1, the sensing device 12-1, the input and output device 13-1, and the communication device 14-1 of the counselor terminal 7-1. However, the measurement target of the actor measurement device 11-2 is a client.

The actor measurement device 11-1 and the actor measurement device 11-2 may be respectively implemented in a separate housing from the counselor terminal 7-1 and the client terminal 7-2. As for the configuration other than the actor measurement device 11, each of the counselor terminal 7-1 and the client terminal 7-2 may be implemented by a plurality of housings including a body and a wearable computer. The input and output device 13-1 and the input and output device 13-2 may function as the actor measurement device 11-1 and the actor measurement device 11-2, respectively. For example, when a counselor or a client feels a specific emotion, an action of the counselor or the client can be measured by pressing a specific button.

The network 9 connects the action processing device 1, the counselor terminal 7-1, and the client terminal 7-2. The network 9 may be implemented by a wide area network such as the Internet or a local network such as a LAN, or may be implemented by a plurality of networks.

The configuration of Embodiment 1 has been described above, and the information used in Embodiment 1, that is, the information and the processing flow stored in the storage device 4 will be described below. At this time, the processing contents will be mentioned. The processing subject basically uses the configuration shown in FIG. 1, and it is clear from the above description of the relationship between FIG. 1 and FIG. 2 that the processing can be performed using the configuration shown in FIG. 2.

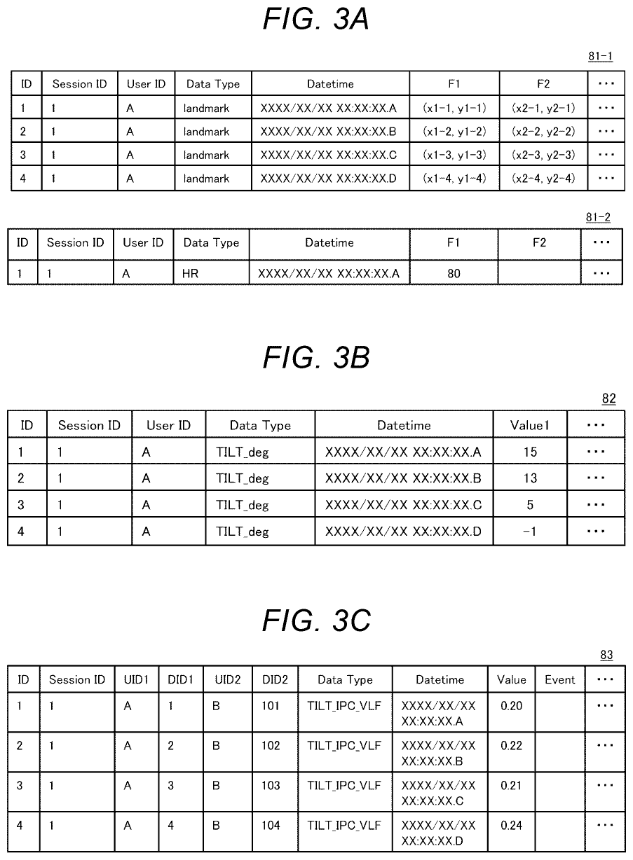

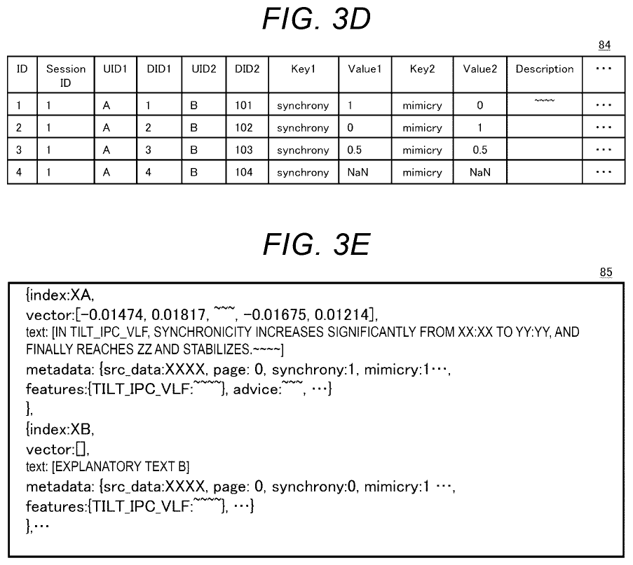

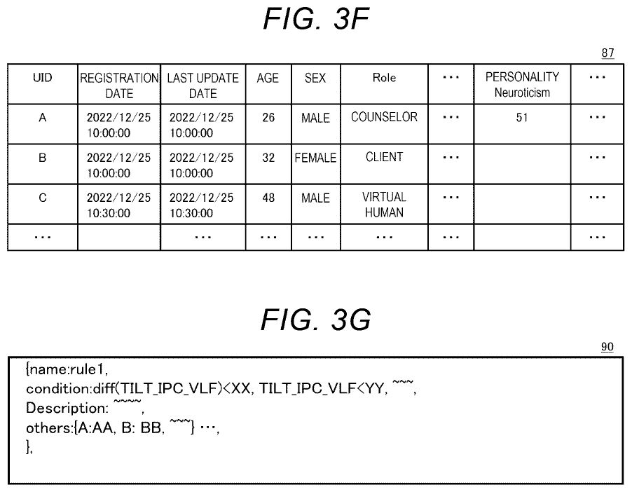

FIG. 3A is a diagram showing the sensing information 81 used in Embodiment 1. In Embodiment 1, sensing information 81-1 indicating a vector amount and sensing information 81-2 indicating a scalar quantity are used as the sensing information 81. Either one of the sensing information 81-1 and the sensing information 81-2 may be used, or they may be managed as one piece of sensing information 81.

First, the sensing information 81-1 is information indicating an action of each action subject (actor) with a vector amount. Therefore, the sensing information 81-1 includes items, ID, Session ID, User ID, Data Type, Datetime, F1, and F2 (up to Fn). The ID is an item for identifying the sensing information 81-1, and a unique identification code (for example, a number) is assigned to each record. The Session ID indicates a measurement unit for an action of an action subject. As the measurement unit, for example, a unit of communication called counseling of one time (one frame) can be used.

The User ID indicates the measured action subject (actor), and in the case of Embodiment 1, identification information indicating either one of the counselor and the client is recorded. The Data Type indicates sensing information 81-1, that is, the type and target of the measured action. In the example shown in FIG. 3A, coordinates of the face denoted by the “landmark” are used. The Datetime is time information related to measurement, and a measured time point, a time point at which the sensing information 81-1 is acquired, and the like can be used.

F1 to Fn represent coordinates measured for each part of the face. For example, a coordinate for each feature part, such as F1 corresponding to nose, and F2 corresponding to eyes, is used. As time passes, records with ID=1, 2, 3 . . . are recorded for landmarks of the action subject A. As a result, in the sensing information 81-1, the actions of the action subjects A and B over time are shown. The number of F1 to Fn is not limited, and may be one or more.

The sensing information 81-2 is information indicating an action of each action subject (actor) with a scalar quantity. Similarly to the sensing information 81-1, the sensing information 81-2 includes items, ID, Session ID, User ID, Data Type, Datetime, F1, and F2 (up to Fn). Hereinafter, differences from the sensing information 81-1 will be described. The Data Type indicates the sensing information 81-2 indicated by the scalar quantity, that is, the type and target of the measured action. In the example shown in FIG. 3A, “HR”, that is, the heart rate is used. Then, the heart rate (for example, per minute), which is an example of the measured scalar quantity, is recorded in F1. When the sensing information 81-1 and the sensing information 81-2 are handled as one piece of information, it is desirable to record information for distinguishing the vector amount and the scalar quantity in the Data Type or the like.

Next, FIG. 3B is a diagram showing the sensing feature 82 used in Embodiment 1. The sensing feature 82 is generated from the sensing information 81 in the preprocessing unit 103 and is information indicating a feature of an action. Therefore, the sensing feature 82 includes items, ID, Session ID, User ID, Data Type, Datetime, and Value 1 (up to Value n).

The ID is an item for identifying the sensing feature 82, and a unique identification code (for example, a number) is assigned to each record. Further, the Session ID indicates a measurement unit for an action of an action subject, and the Session ID of the sensing information 81 that is a generation source of the sensing feature 82 is used.

Similarly to the sensing information 81, the User ID indicates the measured action subject (actor). The Data Type indicates the type of the sensing feature 82. In the example shown in FIG. 3B, the tilt of the face denoted by “TILT deg” is used. This is because the coordinates of the face are used as the sensing information 81-1 shown in FIG. 3A, and the tilt can be calculated from the coordinates of the face. That is, the preprocessing unit 103 calculates the sensing feature 82 (the tilt of the face) based on the sensing information 81-1 (the coordinates of the face). The Datetime is time information related to the measurement, and Datetime in the sensing information 81-1 is used.

Value 1 to Value n indicate sensing features, for example, the tilt (angle) of the face. The number of Value 1 to Value n is not limited, and may be one or more. When a plurality of Values are used, each item can be used for each direction (xyz axis or the like).

Next, FIG. 3C is a diagram showing the group state index 83 used in Embodiment 1. The group state index 83 is an index related to a group, that is, a state of communication between action subjects who are a counselor and a client. Therefore, the group state index 83 includes items, ID, Session ID, UID 1, DID 1, UID 2, DID 2, Data Type, Datetime, Value, and Event.

First, the ID is an item for identifying the group state index 83, and a unique identification code (for example, a number) is assigned to each record. The Session ID indicates a measurement unit for an action of an action subject, and the Session ID of the sensing information 81 or the sensing feature 82 that is a generation source of the group state index 83 is used.

In addition, the UID 1 represents an action subject who communicates and acts. Therefore, the User ID in the sensing information 81 and the sensing feature 82, which represents the measured action subject (actor), is used as the UID 1. The DID 1 identifies data in the action subject represented by the UID 1. That is, the ID in the sensing information 81 or the sensing feature 82 is used.

The UID 2 represents the other action subject who communicates with the UID 1 and acts. Therefore, the User ID in the sensing information 81 and the sensing feature 82, which represents the measured action subject (actor), is also used as the UID 2. The DID 2 identifies data of an action subject represented by the UID 2. That is, the ID in the sensing information 81 or the sensing feature 82 is used. The DID 1 and the DID 2 are time point-synchronized between the counselor terminal 7-1 and the client terminal 7-2, and therefore, the DID 1 and the DID 2 can be associated with each other. As a result, each UID (User ID) and session ID can also be specified from the ID corresponding to the DID.

Data Type indicates the type of the group state index 83. In the example shown in FIG. 3C, “TILT_IPC_VLF”, that is, the synchronicity of the tilt of the face is used. Datetime is time information related to the measurement, and Datetime in the sensing information 81-1 or the sensing feature 82 is used. As described above, the time related to the measurement is synchronized.

The Value shows a numerical value of TILT_IPC_VLF (synchronicity of the tilt of the face). The numerical value is calculated based on the tilt of the face of each of a counselor (A) and a client (B) in the sensing feature 82 by the group state index calculation unit 104. For this reason, a technique such as frequency analysis is used for the group state index calculation unit 104. Accordingly, it is possible to evaluate a relationship between the sensing feature 82 or the sensing information 81 of the counselor and the sensing feature 82 or the sensing information 81 of the client, that is, the communication therebetween. In the example shown in FIG. 3C, it is understood that the numerical value of ID=1 is the lowest, and the degree of synchrony tends to improve as time passes (ID=4 is the highest).

At least a part of the additional information 84 (data information) related to the intervention action corresponding to the evaluation result or the evaluation in the Event. These will be described below.

Next, FIG. 3D is a diagram showing the additional information 84 used in Embodiment 1. The additional information 84 is information on communication of a group, that is, action subjects such as a counselor and a client, and can be used as reference data or training data in evaluation. Therefore, the additional information 84 includes items, ID, Session ID, UID 1, DID 1, UID 2, DID 2, Key 1, Value 1, Key 2, Value 2, and Description. The ID, the session ID, the UID 1, the DID 1, the UID 2, and the DID 2 are the same as those in the group state index 83.

In addition, the Key 1 and the Value 1, the Key 2 and the Value 2 each indicate a relationship related to actions of action subjects. In FIG. 3D, in the case of ID=1, the group, i.e., the counselor (A) and the client (B) has a synchrony of 1 and a mimicry of 0 in the Key 1 and the Value. Hereinafter, these values are recorded for each ID. In Embodiment 1, the additional information 84 is created using measurement results of actual communication, and therefore, the UID 1, the DID 1, the UID 2, and the DID 2 are recorded. When the additional information 84 is artificially created, these items may be omitted, or the role (counselor, client, or the like) may be recorded using the UID 1 and the UID 2. The description of the corresponding record is recorded in the Description.

Next, FIG. 3E is a diagram showing the knowledge database 85 (knowledge DB 85) used in Embodiment 1. At least the sensing information, the group state index, and the vector information are associated with the knowledge DB 85. In Embodiment 1, an explanatory text, which is an example of visible information for generating vector information, is also associated therewith. FIG. 3E shows a plurality of pieces of knowledge data (every index in the drawing). “Vector:” indicates vector information. In addition, “text:” indicates an explanatory text for generating the corresponding vector information. Further, “metadata:” indicates the corresponding additional information. Further, “features:” indicate the corresponding sensing feature. These items correspond to one record in the knowledge DB 85. These pieces of data are examples, and for example, the knowledge DB 85 may include sensing information.

Next, the intervention candidate list 86 is information indicating an intervention candidate list generated in Embodiment 1. Next, FIG. 3F is a diagram showing the action subject property information 87 used in Embodiment 1. The action subject property information 87 is information on an action subject (actor). Therefore, the action subject property information 87 includes items, UID, Registration Date, Last Update Date, Age, Sex, Role, and Personality (Neuroticism). The UID identifies an action subject. The action subject is not limited to a natural person, and a virtual human is also included. The Registration Date indicates a data when the corresponding record is registered, and the Last Update Date indicates a data when the corresponding record is last updated. The Age, Sex, Role, and Personality (Neuroticism) are items respectively indicating attributes and properties of the corresponding action subject. The Role indicates a role of each action subject. Note that the Role in the case of UID=C indicates a virtual human, but a role performed by a virtual human (for example, a product presenter) may be recorded.

Next, FIG. 3G is a diagram showing the intervention determination method 90 used in Embodiment 1. In the intervention determination method 90, a rule for determining whether to intervene in accordance with the action is recorded. For example, conditions are defined in a case where the tilt of the face is equal to or greater than xx degrees, in a case where the synchrony between the action subjects is yy or more, or in a case where the group state index 83 is a predetermined value.

Next, the explanatory support model 91 is a model for generating an intervention candidate from visible information, vector information, additional information, or the like such as an explanatory text. The intervention candidate indicates an intervention action performed by an action subject called a virtual human (product presenter, etc.) or a counselor. It is desirable that an intervention candidate for a natural person is represented by a natural language, and it is desirable that an intervention candidate for a virtual human is created in a format by which the intervention candidate can be controlled. Next, the processing model 92 is a model used for generating visible information such as an explanatory text and video information from the group state index 83.

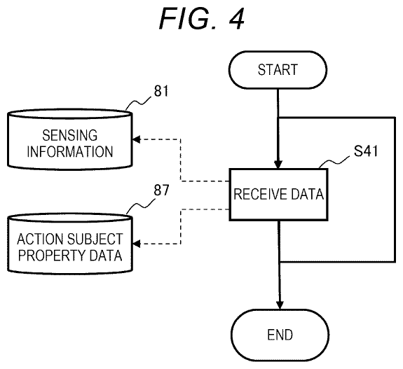

The information used in Embodiment 1 has been described above. Next, the processing flow of Embodiment 1 will be described. FIG. 4 is a flowchart showing sensing information collection processing according to Embodiment 1. In step S41 shown in FIG. 4, the input unit 101 receives the sensing information 81 from the counselor terminal 7-1 or the client terminal 7-2. Then, the preprocessing unit 103 stores the sensing information 81 in the storage unit 109. At this time, the preprocessing unit 103 may access the action subject property information 87 and specify an action subject corresponding to the received sensing information 81. In step S41, the processor 2 receives the sensing information 81 via the communication device 6 in accordance with the reception module 31 in FIG. 2. The sensing information 81 may be received in either a so-called pull-type or push-type.

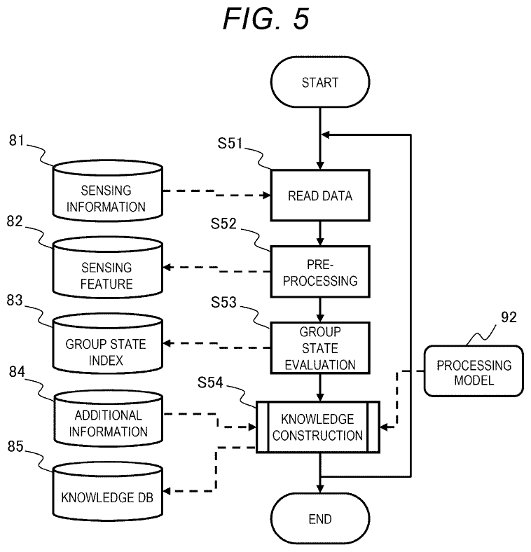

Next, FIG. 5 is a flowchart showing construction processing of the knowledge DB 85 in Embodiment 1. In step S51, the preprocessing unit 103 reads the target sensing information 81 from the storage unit 109. In step 51, the sensing information 81, which is measured by the actor measurement device 11 (various sensors), received from the counselor terminal 7-1 or the client terminal 7-2, and stored in the storage unit 109, is read. Hereinafter, a case in which the group includes two persons, a counselor and a client will be described. In this case, a video image recording communication of the entire group or information measured by a depth sensor is read as the sensing information 81.

As for each of the counselor and the client, a video in which an action of a head is recorded or physiological information such as heart rate, skin electrical activity, or acceleration recorded by the physiological sensor worn by each of the counselor and the client is read as the sensing information 81. The sensing information 81 is acquired by a smartphone or a PC, which is an example of the counselor terminal 7-1 or the client terminal 7-2.

In the case of handling a video for the purpose of recording an action of a head or a face, the video data and feature point data of a head or a face extracted from the video data are handled as the sensing information 81. The feature point data of the head or the face can be created by the sensing device 12 in the counselor terminal 7-1 or the client terminal 7-2. Note that the physiological sensor 21 of the actor measurement device 11 for measuring these actions is not limited to the above. Other sensors for detecting body temperature, blinking, eye movement, electromyography, brain waves, or the like may be used. As the physiological sensor 21, in addition to a wearable computer (device) which can be worn by an action subject, a system built in a smartphone which can be carried around by an action subject can be used.

In step S52, the preprocessing unit 103 calculates the sensing feature 82 based on the read sensing information 81. More desirably, the preprocessing unit 103 performs preprocessing such as noise reduction and outlier processing on the read sensing information 81, performs feature extraction processing, and generates the sensing feature 82 related to each action subject (actor) constituting the group.

First, an example of the preprocessing such as noise reduction will be described. The preprocessing unit 103 may perform used-signal scale normalization processing or noise removal processing on the sensing information 81 for the purpose of correcting an individual difference of the action subjects and reducing the noise. For example, as the normalization processing, the following processing is performed between action subjects for each action subject or each measurement date, or each measurement date of a certain action subject. The normalization processing includes min-max normalization for normalizing by the maximum value and the minimum value, z-score normalization for normalizing by an average value and standard deviation of a signal, and position normalization for normalizing using a distribution point of a signal intensity distribution.

When it is assumed from the age in the action subject property information 87 that the signal intensity will vary due to the aging of an action subject or the like, the preprocessing unit 103 may perform standard deviation processing or the like to normalize the signal intensity for each age group.

The preprocessing unit 103 may perform the following processing as the noise removal processing. That is, processing such as clipping or winsorize processing of removing outliers in the signal and placing them within a certain range, moving average processing of preventing and smoothing sudden fluctuations at a given time point, or zero-order differentiation processing using a Savitzky-Golay filter may be performed.

The preprocessing unit 103 may perform up-sampling or down-sampling using an analog filter or a digital filter for the purpose of reducing a calculation load in subsequent processing and the time granularity between sensing information. The preprocessing such as noise reduction has been described above.

Then, the preprocessing unit 103 performs the feature extraction processing on the preprocessed sensing information 81 and generates the sensing feature 82 related to each action subject (actor) constituting the group. Hereinafter, an example of the feature extraction processing will be described.

The feature extraction processing according to a physiological signal in physiological measurement data serving as the source of the sensing information 81 may be performed. For example, the following feature can be extracted for heartbeat interval data acquired by a heart rate sensor, which is an example of the actor measurement device 11.
Average heart rate in a predetermined time window.
Low Frequency component (LF) which is obtained by frequency domain analysis and is known to mainly reflect a sympathetic nerve activity and a High Frequency component (HF) which is known to mainly reflect a parasympathetic nerve activity.
SDNN, RMSSD, and NN50 used in the time domain analysis.
A feature using a Lorenz plot used in the non-linear domain analysis, a feature obtained by the Detrended Fluctuation Analysis, and a feature obtained by a complex demodulation method.

For electrodermal activity data acquired by an electrodermal activity sensor, which is an example of the actor measurement device 11, a skin conductance level (SCL) or a skin conductance response (SCR) may be used. In the case of triaxial acceleration data obtained from an acceleration sensor as an example of the actor measurement device 11, the feature can be extracted as follows. That is, the acceleration norm or the number of zero crossings, which is the number of times per predetermined time that a signal processed by a band-pass filter for the acceleration norm passes through a threshold value of +0.01 G when gravitational acceleration is 1 G, can be used.

When the feature point data of the face is measured, a three-dimensional Euler angle of a head action may be calculated using feature point coordinates, and NOD/SHAKE/TILT or the like that is the obtained Euler angle may be used as the feature. In this case, for example, a three-dimensional Euler angle of the head in a tilt direction is calculated with TILT_deg. As described above, the preprocessing unit 103 calculates, based on the sensing information 81, the sensing feature 82 indicating a state of each action subject constituting the group. Then, the preprocessing unit 103 stores the sensing feature 82 in the storage unit 109.

In step S53, the group state index calculation unit 104 calculates the group state index 83 based on the sensing feature 82 generated from the sensing information 81. This example will be described below. Here, there are various known group state indices for evaluating the quality of communication and a table method using the group state indices.

For example, in counseling performed between two action subjects, phenomena reflecting representative counseling strategies and communication states, such as Synchrony, Echoing, Mimicry, Mirroring, and Reflection, are known. In Embodiment 1, a state index based on these states is calculated. That is, the group state index calculation unit 104 calculates, based on the sensing feature 82, a group state evaluation index reflecting these states. Hereinafter, an example, in which counseling between two action subjects is taken as an example, and a mind-body synchrony index reflecting Synchrony is calculated as a group state index, will be described.

It is known that there are a plurality of types of mind-body synchrony indices. Hereinafter, interpersonal physiological coherence based on wavelet transform coherence that measures synchrony in a time-frequency domain and transfer entropy that measures a status of information transmission will be exemplified. That is, a method in which the group state index calculation unit 104 calculates the group state index using these methods will be described.

First, wavelet transform coherence (WTC), which is a first example of a mind-body synchrony index, will be described. WTC is a method of quantifying the frequency synchronicity in a time-frequency space based on the wavelet transform. When the frequency scale s and the time shift n are given to a certain signal xn, the continuous wavelet transform can be expressed by the following (Math. 1).

$$Math . 1$$

$${W}_{x} ( s , n ) = {\sum }_{{n}^{′}}^{N - 1} {x}_{n} {φ}_{0} ⋆ \frac{( {n}^{′} - n ) Δ t}{s} \qquad ( MATH . 1 )$$

In this case, * in (Math. 1) represents a complex conjugate, and φ0 represents a wavelet function. Here, a representative wavelet function, which is Morlet wavelet (Math. 2) with ω0=6.0, is used.

$$Math . 2$$

$${φ}_{0} ( η ) = {π}^{- \frac{1}{4}} {e}^{- \frac{1}{2} {η}^{2}} {e}^{i {ω}_{0} η} \qquad ( MATH . 2 )$$

Further, when Wₓ(s, n) and W_{y}(s, n) are determined for each of the two signals xₙ and yₙ and smoothing is performed in the time-frequency domain, WTC is determined using (Math. 3).

$$Math . 3$$

$${WTC}^{2} ≡ {coh}^{2} ( s , n ) = \frac{{\vert {W}_{x} ( s , n ) {W}_{y} ⋆ ( s , n ) \vert}^{2}}{{\vert {W}_{x} ( s , n ) \vert}^{2} {\vert {W}_{y} ⋆ ( s , n ) \vert}^{2}} ∈ [ 0 , 1 ] \qquad ( MATH . 3 )$$

A region with low reliability of analysis called cone of influence (COI) is present in the WTC. Therefore, in the analysis in this example, interpersonal physiological coherence (IPC) obtained by averaging the WTC in the region not corresponding to the COI in a predetermined time-frequency range can be used as the mind-body synchrony index. For example, the group state index calculation unit 104 may set a time width of 30 seconds as the time window with a constant time interval, and perform the following processing. That is, a VLF band is set to a band of 0.004 Hz to 0.04 Hz, an LF band is set to a band of 0.04 Hz to 0.15 Hz, and an HF band is set to a band of 0.15 Hz to 0.40 Hz. Each of five conditions, the LF band, the HF band, the TP (=LF+HF) band, the VLF band, and all bands, may be averaged in the time-frequency direction.

The group state index calculation unit 104 can use, for example, TILT_IPC_VLF, which is the calculated IPC of the VLF band for the head Euler angle TILT, as the group state index 83. In this case, for example, situations of high bodily synchrony are interpreted as reflecting good communication states in a state where synchronicity strategies are highly implemented. Therefore, when the IPC is used as the group state index 83, the state evaluation and the generation of intervention actions described below are performed based on the degree or the change situation of the IPC. As described above, in the first example, the group state index calculation unit 104 calculates the group state index using (Math. 1) to (Math. 3).

Next, a second example of the mind-body synchrony index is transfer entropy (TE). TE is an information flow index for examining the direction (causality) of information transmission based on the information content. The mutual information content I(X; Y) between the signals X and Y can be expressed by (Math. 4) when the probability of the i-th element xᵢ of the signal X is represented by P(xᵢ) and the coupling probability between xᵢ and the j-th element yⱼ of the signal Y is represented by P(xᵢ, yⱼ).

$$Math . 4$$

$$I ( X ; Y ) = {\sum }_{i = 1}^{N} {\sum }_{j = 1}^{M} P ( {x}_{i} , {y}_{j} ) log \frac{P ( {x}_{i} , {y}_{j} )}{P ( {x}_{i} ) P ( {y}_{j} )} \qquad ( MATH . 4 )$$

Here, the mutual information content is symmetric with respect to X and Y, and the direction of the causal cannot be considered, and therefore, an expanded index thereof is TE. When the conditional probability of X conditioned on Y is P(X|Y), TE TY→X indicating the transmission information content from the signal Y to the signal X is calculated by (Math. 5).

$$Math . 5$$

$${T}_{Y \to X} = \sum P ( {X}_{t + τ} , {X}_{t}^{( k )} , {Y}_{t}^{( l )} ) log \frac{P ( {X}_{t + τ} \vert {X}_{t}^{( k )} , {Y}_{t}^{( l )} )}{P ( {X}_{t + τ} \vert {X}_{t}^{( k )} )} \qquad ( MATH . 5 )$$

Here, TE TY→X quantifies whether knowing a remote signal Yₜ at a time point t with a window width of l in addition to a local signal Xₜ at the time point t with a window width of k is meaningful in terms of the information content in predicting a signal X_{t+τ} at a time point τ stepping ahead of the local signal Xₜ₍ₖ₎. It can be understood that TE TY→X is also an index in which the normalization of the time series and the assumption of the causal linearity in the Granger causal analysis are relaxed. Therefore, for example, when there is no prior knowledge of information propagation time in the task, the group state index calculation unit 104 can measure whether the state in a previous step is valid for the prediction of a state in the next step by setting k=l=τ=1 for simplification.

A domain changes in accordance with the difference in the information content included in a signal, and therefore, it is difficult to use the TE TY→X for comparison between subjects. Therefore, several standardization strategies have been proposed to align the domains. That is, the TE is also rewritten as (Math. 6) and (Math. 7) from the viewpoint of entropy H.

$$Math . 6$$

$${T}_{Y \to X} = H ( {X}_{t + τ} \vert {X}_{t}^{( k )} ) - H ( {X}_{t + τ} \vert {X}_{t}^{( k )} , {Y}_{t}^{( l )} ) \qquad ( MATH . 6 )$$

$$Math . 7$$

$${T}_{Y \to X} = H ( {X}_{t + τ} , {X}_{t}^{( k )} ) - H ( {X}_{t}^{( k )} ) - H ( {X}_{t + τ} , {X}_{t}^{( k )} , {Y}_{t}^{( l )} ) + H ( {X}_{t}^{( k )} , {Y}_{t}^{( l )} ) \qquad ( MATH . 7 )$$

Therefore, the group state index calculation unit 104 may perform normalization based on the formulation based on the entropy, and may use the normalized TE and NTE shown in (Math. 8).

$$Math . 8$$

$$normalized {T}_{Y \to X} = \frac{{T}_{Y \to X}}{H ( {X}_{t + τ} \vert {X}_{t}^{( k )} )} ∈ [ 0 , 1 ] \qquad ( MATH . 8 )$$

For example, when the average heart rate or the acceleration norm is used as the sensing feature, the signal is a continuous signal and is a non-negative signal whose domain changes in accordance with the subject. Therefore, the group state index calculation unit 104 may perform min-max normalization of the signal, set the number of bins n using the Sturges formula (Math. 9) with an analytic signal length being l, and perform binning at equal intervals.

$$Math . 9$$

$$n = {log}_{2} l + 1 \qquad ( MATH . 9 )$$

In this case, for example, when the analytic signal length of the sensing feature 82 is 720 points, the group state index calculation unit 104 may select binning with a bin width at which the number of bins is 11. When the number of zero crossings, which is a discrete signal, is used as the sensing feature 82, the group state index calculation unit 104 may use the discrete value as the bin.

When using the Euler angle (nod/shake/tilt) as the sensing feature 82, the group state index calculation unit 104 may perform binning as follows. That is, from the feature that the position directly facing the screen by the positive and negative continuous signals is 0, the normalization is performed with the absolute maximum value with a center set to 0, and binning is performed at an equal interval such that the bin number 11 of the Sturges formula is obtained.

From the above, in the binning, TE or NTE can be used as the group state index 83 based on binning. In the above, binning is used to estimate the probability distribution between the target sensing features 82, but Embodiment 1 is not limited to this example. For example, a kernel density estimation may be used instead of binning. In this way, in the second example, the group state index calculation unit 104 calculates the group state index using (Math. 4) to (Math. 9).

As described above, the group state index calculation unit 104 calculates the group state index 83 reflecting a communication state of a group using the sensing feature 82 of each action subject (actor) constituting the group. Then, the group state index calculation unit 104 stores the calculated group state index 83 in the storage unit 109.

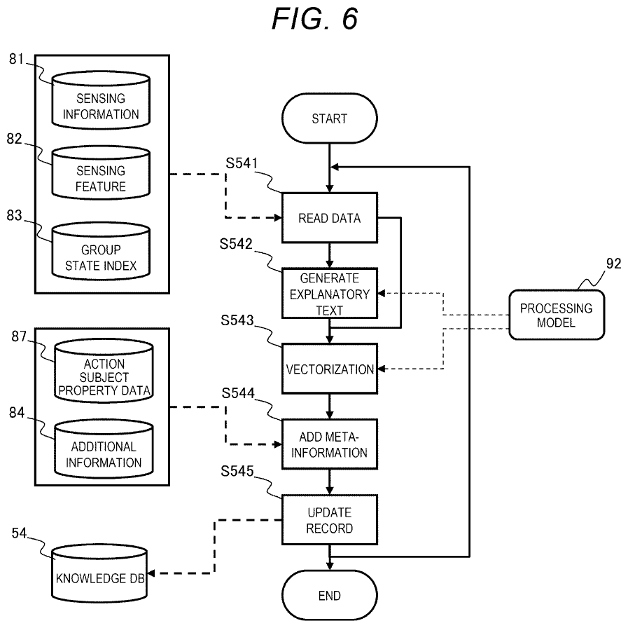

In step S54, the vector information generation unit 105 constructs the knowledge DB 85 based on the group state index 83. The construction includes generation and update of the knowledge DB 85. For this reason, the vector information generation unit 105 generates the sensing information 81 and/or the sensing feature 82 and an explanatory text and vector information for the group state index 83. Then, the vector information generation unit 105 constructs the knowledge DB 85 in association with these knowledges. In Embodiment 1, it is more desirable that the vector information generation unit 105 constructs the knowledge DB 85 by associating the additional information 84 as necessary. The generation of the explanatory text and the vector information will be described below with reference to FIG. 6. Therefore, the additional information 84 will be described here. In step S54, the vector information generation unit 105 may construct the knowledge DB 85 using at least one of the sensing information 81 and the group state index 83.

In Embodiment 1, the sensing information 81 and/or the sensing feature 82, the group state index 83, the explanatory text, and the vector information constituting the knowledge DB 85 are used as knowledge, and the additional information 84 is desirably associated with meta-information of the knowledge record. For example, it is assumed that the vector information generation unit 105 uses information on a session that becomes a model related to a good or poor communication state when constructing the knowledge DB 85. In this case, meta-information is used to provide labeled information and explanations regarding what perspective does the session serve as a model for. The meta-information (additional information 84) will be described below in step S544 shown in FIG. 6. In Embodiment 1, the knowledge DB 85 can be updated in addition to the knowledge DB 85 shown in FIG. 5. The update includes addition of a record to the knowledge DB 85 and addition of the knowledge DB itself. Further, the update includes update of the explanatory text and the vector information included in the knowledge DB 85. Therefore, the update will be described below with reference to FIG. 6, that is, the generation of the explanatory text and the vector information.

FIG. 5 has been described above.

Next, the generation of the explanatory text and vector information in step S54 will be described. For this reason, first, the vector information generation unit 105 generates an explanatory text based on the group state index 83. Further, the vector information generation unit 105 may generate an explanatory text based on the sensing information 81. In this case, it is desirable to use the sensing feature 82 generated from the sensing information 81. Alternatively, the sensing information 81 itself may be used. The vector information generation unit 105 may generate an explanatory text based on both the sensing information 81 and the group state index 83. Then, the explanatory text is vectorized to generate vector information. In this example, the explanatory text is used as an example of the visible information. Alternatively, the vector information generation unit 105 may generate video information as the visible information and generate vector information from the video information. Further, the vector information generation unit 105 may generate an explanatory text and video information and generate vector information from the explanatory text and the video information. At this time, the vector information generation unit 105 may generate the vector information by selectively using one of the generated explanatory text and video information, or may generate the vector information using both.

The details will be described below with reference to FIG. 6. FIG. 6 is a flowchart showing generation processing of the explanatory text and the vector information in Embodiment 1. In step S541, the vector information generation unit 105 reads raw data such as the sensing information 81, the sensing feature 82, and the group state index 83 from the storage unit 109. In the present embodiment, the vector information generation unit 105 reads the group state index 83 in accordance with the configuration of the knowledge DB 85, and sets the group state index 83 as a processing target. However, the vector information generation unit 105 may further read the sensing information 81 and the sensing feature 82. Further, other necessary data may be read in combination.

In step S542, the vector information generation unit 105 generates an explanatory text based on the read information, more preferably the group state index 83. Hereinafter, only processing for the group state index 83 will be described below. However, the processing for the sensing information 81 and the sensing feature 82 is the same as the processing for the group state index 83, and therefore, description of the processing for the sensing information 81 and the sensing feature 82 is omitted. As described in step S54, the explanatory text is an example of visible information, and in step S542, the video information may be generated or both the explanatory text and the video information may be generated.

First, the premise will be described. In the evaluation of the nonverbal response technique, an expert can make qualitative evaluation of the communication state or the group state index 83. However, a method of digitizing the nonverbal response technique is not disclosed so far, and the evaluation is difficult only by mechanically viewing numerical information of the nonverbal response technique. In this case, in Embodiment 1, by substituting the qualitative evaluation of the expert, the group state index 83 is converted into a language via the explanatory text, and the explanatory text is vectorized and handled, so that mechanical evaluation is enabled. The explanatory text is an example of visible information, and video information or the like can be used. That is, the group state index 83 may be visualized via the visible information. The visible information is preferably editable. In Embodiment 1, the action of the second group is evaluated based on the sensing information, and therefore, an action related to communication including the nonverbal response technique in a group can be more appropriately evaluated.

Then, the vector information generation unit 105 generates, for the group state index 83, an explanatory text describing an absolute value and a time-series change of the group state index 83 from the viewpoint of a predetermined language using the processing model 92. For example, a template similar to a large language model (LLM) and prompt or setting information which is an instruction for the LLM is defined as the processing model 92.

The vector information generation unit 105 inputs the raw data or the image data of the group state index 83 to the processing model 92 to generate an explanatory text. For example, when TILT_IPC_VLF is used as the group state index 83, the vector information generation unit 105 generates the following explanatory text.

“In TILT_IPC_VLF, synchronicity increases significantly from XX:XX to YY:YY, and finally reaches ZZ and stabilizes. ˜˜˜˜”. This is an explanatory text in which a qualitative evaluation performed by an expert is verbalized in natural sentence. This content is indicated as “text” in FIG. 3E. In the above-described generation of the explanatory text, an explanatory text may be generated from one group state index 83, or an explanatory text may be generated based on a result of combining a plurality of group state indices 83. Further, step S542 may be skipped, and the vector information may be generated from the sensing information 81 or the like in step S543.

In step S543, the vector information generation unit 105 vectorizes the generated explanatory text to generate vector information. The vector information generation unit 105 may vectorize the group state index 83. Hereinafter, an example of step S543 will be described.

The vector information generation unit 105 uses, for example, the processing model 92 including the LLM, the prompt, and the template. In this case, the vector information generation unit 105 calculates an Embedding vector for the generated explanatory text and generates the Embedding vector as vector information. This content is shown as “vector” in FIG. 3E.

In addition, when the group state index 83 is vectorized, the vector information generation unit 105 may vectorize the group state index 83 using dimension reduction of features based on the LLM, other known machine learning, or statistical processing. According to the above two kinds of processing, it is possible to obtain vector information as feature that reflects the communication state while retaining a certain degree of information from the raw data and also incorporating the qualitative evaluation viewpoint that has commonly been used by experts.

The processing model 92 used for generating or vectorizing the explanatory text is not limited to the LLM and may be used as necessary. For example, in the generation of the explanatory text, when necessary explanatory text is simple, a known caption generation model in which the group state index 83 is imaged and a caption is attached to the image can be used. In addition, the explanatory text may be generated by extracting the time series changes or absolute values of the group state index 83 under predetermined conditions and inputting them into an explanatory text template.

In addition, in the vectorization, a natural sentence or a time-series signal may be vectorized into a fixed-length vector. Therefore, for example, a deep learning model that enables dimension reduction or a known algorithm may be used. In this example, a long short-term memory (LSTM), a convolutional neural network (CNN), a transformer, an auto encoder (AE), or the like may be used as a deep learning model. Further, principal component analysis, uniform manifold approximation and projection (UMAP), or the like may be used as a known statistical or machine learning algorithm.

Here, an explanatory text is used as an example of visible information, and as described above, video information may also be used. That is, in step S543, the vector information generation unit 105 can generate vector information by vectorizing at least one of the explanatory text and the video information.

Then, in step S544, the vector information generation unit 105 adds the additional information 84 which is meta-information. An example will be described below. The following is used as meta-information for communication between two persons. First, flag information (metadata{synchrony:1, mimicry:1, ˜˜}) is used to indicate whether the session to be used as a reference for Synchrony, Echoing, Mimicry, Mirroring, or Reflection.

In addition, as the additional information 84, definitions and attention items (metadata{advice:˜˜}) for taking the strategy may be used. An ID or storage information (metadata{src_data:˜˜}) of data used for generating an explanatory text or vector information may be used. As the additional information 84, raw data itself (metadata{features:{TILT_IPC_VLF:˜˜}}) such as the sensing information 81, the sensing feature 82, and the group state index 83 may be used.

In the generation of the intervention action using the knowledge DB 85 described below, the intervention action generation unit 107 uses the necessity of the intervention candidate proposal as the state evaluation. In this case, known methods such as k-nearest neighbor (kNN) or approximate nearest neighbor method (ANN) are used. That is, the intervention action generation unit 107 extracts the vectorized information having the similarity matching the predetermined condition from the knowledge DB 85, and specifies the necessity of the intervention candidate proposal from the extraction result and the condition (intervention determination method) for determining whether the intervention action generation is necessary. As a result, when it is determined that the intervention candidate proposal is necessary, the intervention action generation unit 107 generates an intervention action candidate list for the explanatory text, the vectorized information, and the additional information 84 of the extracted knowledge record group. The intervention action candidate list may be generated by generating an intervention action candidate to be taken by the counselor in a natural sentence or may be generated as the explanatory support model 91 for generating an operation plan of an actuator necessary for generating an action of a system or a virtual human. Here, the action of the virtual human is generated in Embodiment 2. The generation of these intervention action candidate lists is executed based on a rule or a pattern for generating a predetermined intervention action by inputting the explanatory text, the vectorized information, and the additional information 84 of the extracted knowledge record group.

In step S545, the vector information generation unit 105 adds the explanatory text, the vector information, and the additional information 84 generated in step S542 to step S544 to the knowledge DB 85 to update the record. In step S541 to step S545, the target raw data (sensing information 81 and the like) is repeatedly executed.

As described above, in Embodiment 1, the knowledge DB 85 is constructed using the results measured for the action, and may be constructed manually.

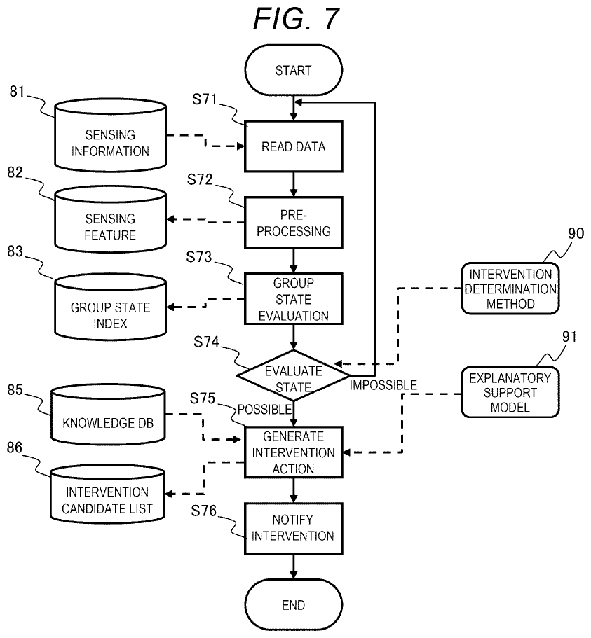

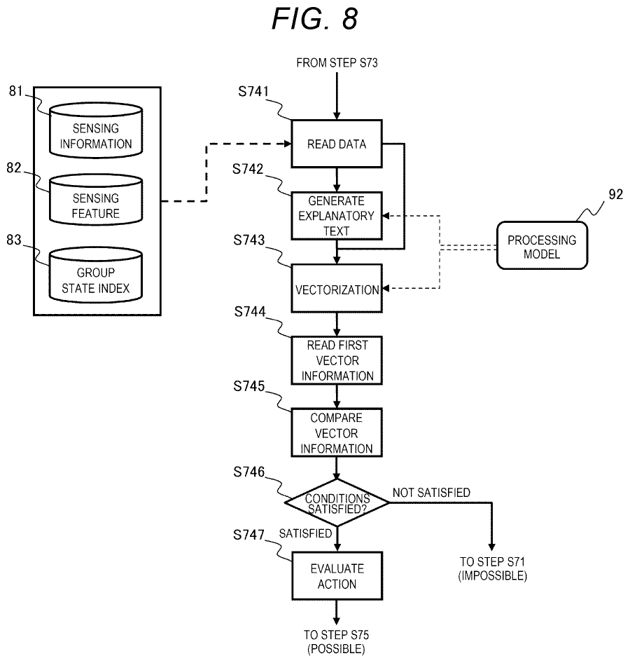

Here, the update of the knowledge DB 85, in particular, the update of an explanatory text and vector information will be described. The knowledge DB 85 is updated by reflecting evaluation results in action evaluation processing (FIG. 7 and FIG. 8) described below in the knowledge DB 85. At this time, the processing is executed according to the flowchart shown in FIG. 5. In particular, the vector information generation unit 105 corrects an explanatory text, which is an example of the visible information, in accordance with the evaluation result in the action evaluation processing, and generates the vector information in accordance with the corrected explanatory text. This processing is executed as shown in the flowchart of FIG. 6. As a result, it is possible to improve the accuracy of information such as the group state index, the explanatory text, and the vector information which are stored in the knowledge DB 85. As described above, in Embodiment 1, the information in the knowledge DB 85 of the first group can be expanded by using not only an evaluation of the information of the knowledge DB 85 of the second group to be evaluated in the action evaluation processing but also the processing result of the second group.

Next, group action evaluation processing using the knowledge DB 85 will be described. FIG. 7 is a flowchart showing action evaluation processing according to Embodiment 1. In step S71 to step S73 shown in FIG. 7, the same processing as step S51 to step S53 shown in FIG. 5 is executed. However, in step S71 to step S73, processing is performed on a group to be evaluated. Hereinafter, a group to be handled in step S51 to step S53 is referred to as a first group, and a group to be evaluated is referred to as a second group.

Then, in step S74, the vector information generation unit 105 and the action evaluation unit 106 evaluate the action of the second group. As a result, if the action of the second group can be evaluated (possible), the processing proceeds to step S75, and if the action of the second group cannot be evaluated (impossible), the processing returns to step S71. Hereinafter, an example of the evaluation processing in step S74 will be described.

FIG. 8 is a flowchart showing details of step S74 in the action evaluation processing in Embodiment 1. First, in step S741 to step S743, the same processing as step S541 to step S543 shown in FIG. 6 is executed. In step S541 to step S543, data of the first group is used, but in step S741 to step S743, data of the second group is used. As a result, the second vector information, which is the vector information of the second group, is generated in step S743.

In step S744, the vector information generation unit 105 reads the first vector information, which is the vector information of the first group, from the knowledge DB 85 of the storage unit 109. In step S745, the vector information generation unit 105 compares the first vector information read in step S744 with the second vector information generated in step S743.

Then, in step S746, the vector information generation unit 105 determines whether the comparison result in step S745 satisfies a predetermined condition. As this condition, at least one of the following (1) to (3) can be used.

(1) A difference between the first vector information and the second vector information is within a predetermined threshold value.

(2) The communication or action in the second group can be improved to a certain value or more by the first vector information.

(3) The intervention action that can improve communication or an action of the second group can be specified based on the first vector information.

As a result of the determination in step S746, if the condition is satisfied (for example, the difference is within the threshold value), the processing proceeds to step S747. If the condition is not satisfied, the processing returns to step S71. That is, it is determined to be impossible in step S74.

In step S747, the vector information generation unit 105 evaluates the action or communication of the second group based on the first group state index associated with the first vector information determined to satisfy the condition in step S746. For this reason, for example, the action evaluation unit 106 specifies the action of the second group based on the first sensing information and/or the first group state index corresponding to the first vector information satisfying the condition. The action and communication of the second group can be evaluated based on the sensing information and/or the first group state index. Therefore, it can be understood that the action and communication of the second group are specified and output to evaluate itself. FIG. 8 has been described above, and returning to FIG. 7, the action evaluation processing will be described further.

Next, in step S75, the intervention action generation unit 107 generates an intervention action for the second group in accordance with the evaluation result in step S747. The details have already been described in step S544, and therefore, the details will be omitted. Then, in step S76, the output unit 102 notifies the generated intervention action. For this reason, for example, the processor 2 issues the notification of the intervention action via the communication device 6 in accordance with the notification module 37. The processor 2 may display the intervention action on the input and output device 5 in accordance with the notification module 37.

The counselor terminal 7-1 is desirably notified of the intervention action. Alternatively, the client terminal 7-2 may be notified. As a result, the counselor terminal 7-1 and the client terminal 7-2 can display the intervention action. In step S76, the contents of the knowledge DB 85 may be further included in the second group. That is, the sensing information 81, the sensing feature 82, the group state index 83, the explanatory text, and the vector information of the second group may be notification targets. FIG. 7 has been described above, and a display screen of the notification in step S76 will be described.

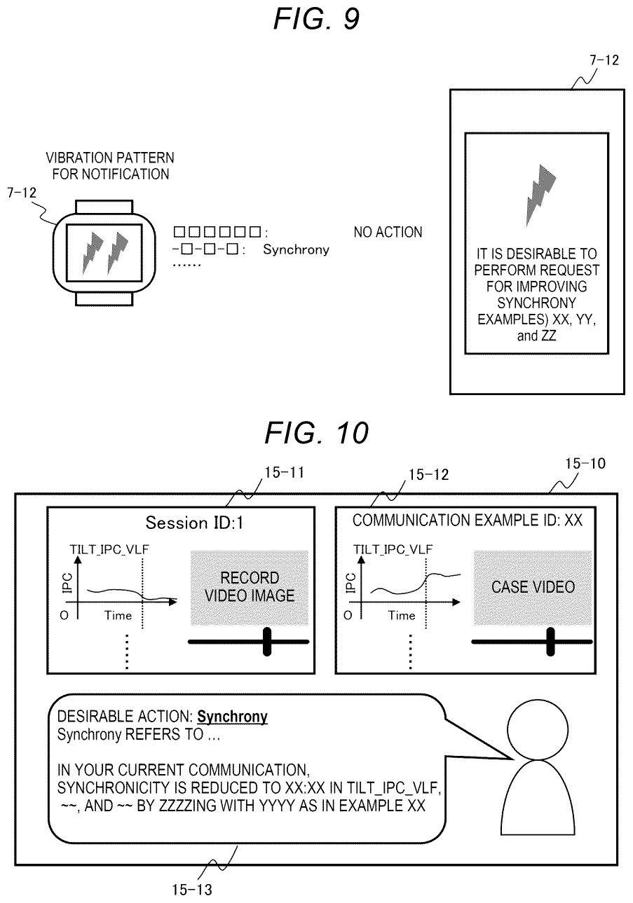

FIG. 9 is a diagram showing a display screen of the intervention action in Embodiment 1. FIG. 9 shows an example in which the counselor terminal 7-1 is set as a notification destination, and the counselor terminal 7-1 includes a counselor terminal body 7-11 and a wearable computer 7-12 which are linked to each other. In FIG. 9, a wristwatch-type wearable computer 7-12 is shown, and the form thereof is not limited thereto.

First, when the notification in step S76 is received, the wearable computer 7-12 displays an alert indicating that the intervention action is notified. This display is performed by the notification device 15-1 shown in FIG. 2. When the counselor operates the counselor terminal body 7-11, the notification content is displayed on the display screen. This display is also performed by the notification device 15-1 shown in FIG. 2. In the example shown in FIG. 9, a notification content in which an encouragement to improve synchrony is proposed as an action is displayed.

Here, FIG. 9 shows contents of the notification and the display in real-time processing during or immediately after the communication each time an intervention action is generated in step S75. However, notification processing may be performed for retrospective review after the communication, for example, counseling, is completed. Next, the notification for retrospective review will be described.

FIG. 10 is a diagram showing a display screen of another intervention action in Embodiment 1. In other words, FIG. 10 shows the display content for the retrospective review. In FIG. 10, the notification destination is the counselor terminal 7-1, and the display is performed on the notification device 15-1 shown in FIG. 2. In FIG. 10, a display screen 15-10 of the notification device 15-1 includes a first display region 15-11, a second display region 15-12, and a third display region 15-13. The notification for the second group is displayed on these regions.

First, “TILT_IPC_VLF” which is an example of the group state index 83 and image data which is an example of the sensing information 81 when a predetermined Session ID (measurement unit)=1 are displayed on the first display region 15-11. That is, the above-described raw data by which the knowledge DB 85 can be constructed is displayed on the first display region 15-11.

On the other hand, the generated intervention action is displayed on the second display region 15-12 and the third display region 15-13. First, the same items as the first display region 15-11, that is, “TILT_IPC_VLF” which is an example of the group state index 83, and the image data which is an example of the sensing information 81, are displayed on the second display region 15-12. In addition, as in the case of FIG. 9, a notification content in which an encouragement to improve synchrony is proposed as an action is displayed on the third display region 15-13. The contents shown in FIGS. 9 and 10 may be displayed on the input and output device 5 of the action processing device 1. Embodiment 1 has been described above.

### Embodiment 2

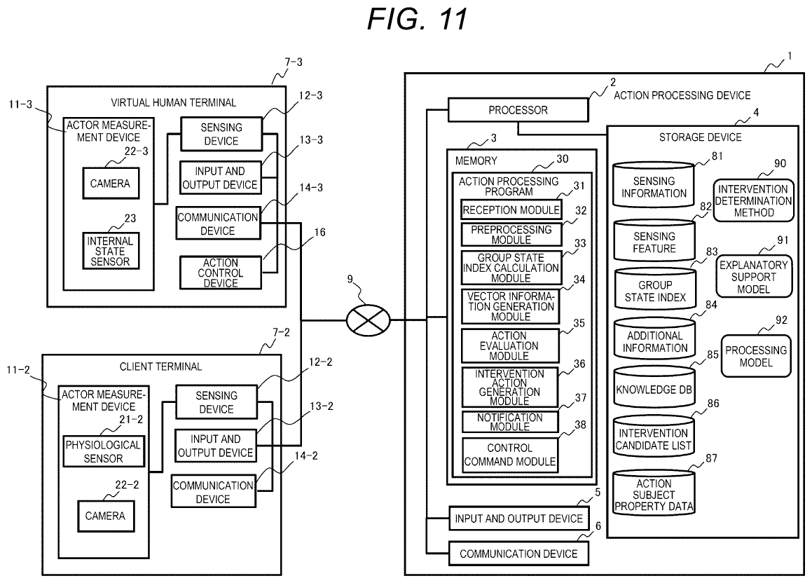

In Embodiment 1, the communication between natural persons is evaluated. In Embodiment 2, an example in which one is a virtual human is shown. First, FIG. 11 is a configuration diagram showing an implementation example of an action processing system according to Embodiment 2. Hereinafter, the difference between FIG. 11 and FIG. 2 will be mainly described.

In FIG. 11, a virtual human terminal 7-3 is used instead of the counselor terminal 7-1 shown in FIG. 2. The virtual human terminal 7-3 includes an actor measurement device 11-3, a sensing device 12-3, an input and output device 13-3, a communication device 14-3, and an action control device 16, which are connected to one another via a communication path. Among these, the sensing device 12-3, the input and output device 13-3, and the communication device 14-3 can be configured similarly to those of the counselor terminal 7-1.

However, in the actor measurement device 11-3, an internal state sensor 23 is provided instead of the physiological sensor 21-1. The internal state sensor 23 is a modified version of the physiological sensor 21-1 and used for a virtual human, such as a robot or an avatar. That is, the internal state sensor 23 has a function as an actuator joint angle sensor and has a function of specifying time-series avatar body movements for the virtual human. Therefore, the internal state sensor 23 is not limited to a sensor in a narrow sense that detects a physical quantity, and has a function of specifying an internal state of software or the like. The action control device 16 is a control device that controls a virtual human. When the virtual human is a robot that physically acts, or the like, an actuator that performs this action is connected to the action control device 16.

The virtual human terminal 7-3 may execute a function of a virtual human, that is, an action related to communication. In addition, functions of the virtual human may be executed by a device other than the virtual human terminal 7-3.

Further, a control command module 38 of the action processing program 30 is added to the action processing device 1, as compared with the action processing device 1 according to Embodiment 1. The control command module 38 is used for executing the function of the control command unit 108 shown in FIG. 1, and the processor 2 creates a control command for the virtual human based on the intervention action in accordance with the control command module 38. The processor 2 notifies the action control device 16 of the control command via the communication device 6 in accordance with the control command module 38. Upon receiving the control command, the action control device 16 controls the virtual human. For example, the action control device 16 operates the actuator of the robot in accordance with the control command. In Embodiment 2, the control command module 38 (control command unit 108) may also be omitted. In this case, the action control device 16 of the virtual human terminal 7-3 creates a control command in accordance with the intervention action notified from the action processing device 1. As a result, the actuator of the virtual human operates, that is, is controlled based on the created control command.

The information used in Embodiment 2 is the same as that of Embodiment 1, and therefore, the description thereof is omitted. Next, a processing flow according to Embodiment 2 will be described. The sensing information collection processing, the construction processing of the knowledge DB 85, and the generation processing of the explanatory text and the vector information according to Embodiment 2 are the same as those of Embodiment 1. The processing has already been described with reference to FIGS. 4 to 6, and therefore, the detailed description thereof will be omitted. Of course, in the sensing information collection processing according to Embodiment 2, the construction processing of the knowledge DB 85, and the generation processing of the explanatory text and the vector information, the target is not a counselor but a virtual human.

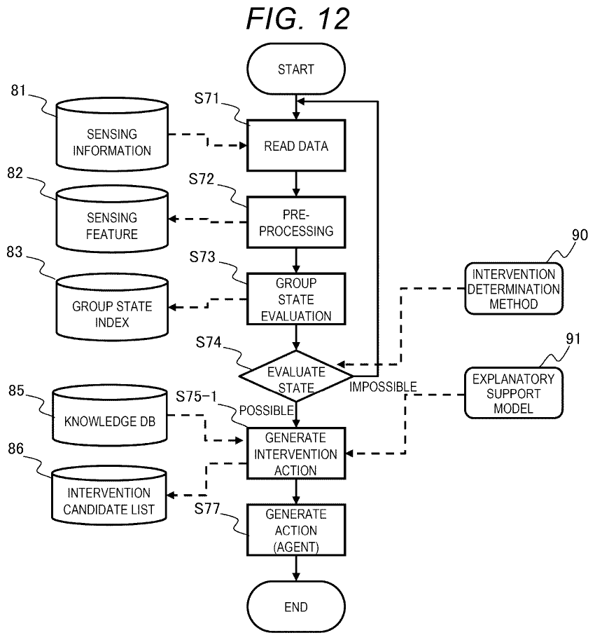

Next, the action evaluation processing according to Embodiment 2 will be described. FIG. 12 is a flowchart showing action evaluation processing according to Embodiment 2. In FIG. 12, step S71 to step S74 are the same as those in FIG. 7 according to Embodiment 1.

Then, in step S75-1, the intervention action generation unit 107 generates an intervention action for the second group, that is, an intervention action for an e-intention, in accordance with the evaluation result in step S747. Specifically, the intervention action generation unit 107 extracts the vectorized information having the similarity matching the predetermined condition from the knowledge DB 85, and specifies the necessity of the intervention candidate proposal from the extraction result and the condition (intervention determination method) for determining whether the intervention action generation is necessary. As a result, when it is determined that the intervention candidate proposal is necessary, the intervention action generation unit 107 generates an intervention action candidate list for the explanatory text, the vectorized information, and the additional information 84 of the extracted knowledge record group. In Embodiment 2, the intervention action generation unit 107 generates an intervention candidate list for generating an operation plan or the like of the actuator necessary for the action generation of the virtual human using the explanatory support model 91. Then, the control command unit 108 generates a control command in which the intervention candidate list is embodied. The intervention candidate list itself may be treated as a control command. In this case, the control command unit 108 can be omitted.

Then, in step S77, the intervention action generated in step S75 is executed in the virtual human. For this reason, the output unit 102 notifies the virtual human terminal 7-3 of the generated control command. For this reason, for example, the processor 2 issues notification of the control command or the intervention action via the communication device 6 in accordance with the notification module 37. The processor 2 may display the intervention action on the input and output device 5 in accordance with the notification module 37.

When the virtual human terminal 7-3 receives the control command or the intervention action notified by the communication device 14-3, the action control device 16 controls the action of the virtual human accordingly. In Embodiment 2, the intervention action for the virtual human is generated. The same procedure as in Embodiment 1 may be performed for a client (natural person).

The embodiments have been described above, but the invention is not limited to the embodiments. For example, the invention may be implemented by combining Embodiment 1 and Embodiment 2. In this case, a group including three or more action subjects is evaluated, which includes a mixture of a natural person and a virtual human. In this case, both the control for the e-person and the notification of the evaluation result can be performed. Further, an administrator terminal used by a user (administrator) such as a supervisor may be connected to the action processing device 1, and the evaluation result may be notified here. In this case, the administrator can perform evaluation for communication such as counseling of a counselor, or evaluation for the counselor himself.

What is claimed is:

1. An action processing device for evaluating an action related to communication of a group of action subjects performing the communication with each other, the device comprising:
a storage unit configured to store a knowledge database in which a first group state index related to a state of communication in a first group is associated with first vector information generated based on the first group state index and indicating a feature of the action;
an input unit configured to receive second sensing information indicating an action related to communication in a second group;
a group state index calculation unit configured to calculate a second group state index related to a state of the communication in the second group based on the second sensing information;
a vector information generation unit configured to generate visible information indicating a state related to the communication of the second group based on the second group state index and to generate second vector information by vectorizing the visible information; and
an action evaluation unit configured to evaluate the action of the second group based on a first group state index associated with a piece of first vector information whose comparison result with the second vector information satisfies a predetermined condition among pieces of the first vector information included in the knowledge database.

2. The action processing device according to claim 1, wherein
the vector information generation unit generates an explanatory text or video information indicating a state related to communication of a group as the visible information.

3. The action processing device according to claim 2, wherein
the group state index calculation unit calculates a first group state index related to the state of the communication in the first group based on first sensing information related to the communication of the first group,
the vector information generation unit generates a first explanatory text or first video information indicating a state related to the communication of the first group based on the first sensing information or the first group state index, and generates the first vector information by vectorizing the first explanatory text or the first video information, and
the storage unit stores the generated first vector information.

4. The action processing device according to claim 1, wherein
the action evaluation unit identifies the action of the second group based on first sensing information and the first group state index related to the communication of the first group corresponding to the first vector information satisfying the condition, and
the action processing device further includes an output unit configured to output the action of the second group.

5. The action processing device according to claim 4, wherein
the output unit outputs an evaluation result obtained by the action evaluation unit.

6. The action processing device according to claim 1, wherein
first sensing information related to the communication of the first group and the second sensing information are nonverbal information indicating a nonverbal action.

7. The action processing device according to claim 1, wherein
the first group state index and the second group state index include at least one of a synchrony index and an information flow index of the action subject in the action.

8. The action processing device according to claim 1, wherein
the knowledge database further includes additional information on a nonverbal response technique in the state of the communication of the first group.

9. The action processing device according to claim 4, further comprising:
an intervention action generation unit configured to generate an intervention action for an action subject in the second group in accordance with the action identified by the action evaluation unit.

10. The action processing device according to claim 9, wherein
the action subject in the second group includes a virtual human, and
the action processing device further includes a control command unit configured to create a control command for controlling the virtual human in accordance with the intervention action.

11. The action processing device according to claim 1, wherein
the action evaluation unit evaluates the action of the second group by further using first sensing information associated with the first vector information within a threshold value.

12. The action processing device according to claim 1, wherein
the condition is at least one of a condition that a difference between the first vector information and the second vector information is within a predetermined threshold value, and the communication is improved by a certain value or more according to the first vector information, and a condition that an intervention action of improving the communication is identifiable based on the first vector information.

13. The action processing device according to claim 10, wherein
an actuator is controlled based on the created control command.

14. An action processing method executed by an action processing device for evaluating an action related to communication of a group of action subjects performing the communication with each other, the method comprising:
storing, by a storage unit, a knowledge database in which a first group state index related to a state of communication in a first group is associated with first vector information generated based on the first group state index and indicating a feature of the action;
receiving, by an input unit, second sensing information indicating an action related to communication in a second group;
calculating, by a group state index calculation unit, a second group state index related to a state of the communication in the second group based on the second sensing information;
generating, by a vector information generation unit, visible information indicating a state related to the communication of the second group based on the second group state index and generating second vector information by vectorizing the visible information; and
evaluating, by an action evaluation unit, the action of the second group based on a first group state index associated with a piece of first vector information whose comparison result with the second vector information satisfies a predetermined condition among pieces of the first vector information included in the knowledge database.

15. A storage medium storing an action processing program causing an action processing device that is a computer for evaluating an action related to communication of a group of action subjects performing the communication with each other to function as:
a storage unit configured to store a knowledge database in which a first group state index related to a state of communication in a first group is associated with first vector information generated based on the first group state index and indicating a feature of the action;
an input unit configured to receive second sensing information indicating an action related to communication in a second group;
a group state index calculation unit configured to calculate a second group state index related to a state of the communication in the second group based on the second sensing information;
a vector information generation unit configured to generate visible information indicating a state related to the communication of the second group based on the second group state index and to generate second vector information by vectorizing the visible information; and
an action evaluation unit configured to evaluate the action of the second group based on a first group state index associated with a piece of first vector information whose comparison result with the second vector information satisfies a predetermined condition among pieces of the first vector information included in the knowledge database.
